(19) United States
(12) Patent Application Publication
(10) Pub. No.: US 2015/0096974 A1
(43) Pub. Date: Apr. 9, 2015

(54) MODULAR DOMESTIC COOKING APPLIANCE WITH CUSTOMIZABLE COOKING BAYS/ MODULES

(71) Applicant: BSH Home Appliances Corporation, Irvine, CA (US)

(72) Inventors: John Freeman, Knoxville, TN (US); Samuel Harward, Knoxville, TN (US); Jeremiah Nash, Knox, TN (US)

(73) Assignee: BSH Home Appliances Corporation, Irvine, CA (US)

(21) Appl. No.: 14/048,207

(22) Filed: Oct. 8, 2013

(51) Int. Cl. F24C 1/00; H05B 1/02; F24C 15/10

(52) U.S. Cl. CPC F24C 1/00; F24C 15/106; H05B 1/0261
USPC 219/485; 99/339; 99/340; 99/342; 29/407.01

(57) ABSTRACT

A domestic cooking appliance includes a plurality of bays adapted to receive a plurality of different types of modules; a module connected to a bay of the plurality of bays; and a controller, wherein the controller is adapted to determine the bay in which the module is connected and a type of the module of the plurality of different types of modules. A method of controlling a domestic cooking appliance includes connecting a module of a plurality of different types of modules to the domestic cooking appliance; determining a type of the module; determining a position where the module is connected out of a plurality of possible positions; and displaying the type and the location of the module on a display of the domestic cooking appliance.

### FIELD OF THE TECHNOLOGY

The present technology relates to a domestic cooking appliance. More particularly, the present technology relates to an enhancement for a domestic cooking appliance where different modules can be detected and/or controlled.

### BACKGROUND

In the modern kitchen, one common appliance is a domestic cooking appliance, e.g., a cooktop, which may be a stand alone unit or combined with other devices such as an oven or range. Most domestic cooking appliances include one or more heat generating or cooking devices. Some common devices include gas burners, resistive heaters, and inductive heaters, all of which can be provided in various sizes and configurations.

Generally, domestic cooking appliances come with a fixed configuration of heat generating devices, typically of one type. For example, a domestic cooking appliance usually includes only one of gas, resistive or inductive heating. A common configuration is one large, two medium and one small heat generating device.

### BRIEF SUMMARY

Custom kitchens are very desirable in contemporary households. To meet the need of customizable kitchens, custom appliances are also desirable. However, in order to meet a desired level of customization, a very large number of traditional domestic cooking appliances would need to be provided by a single manufacturer because more than the more common heat generating devices such as gas burners, resistive heaters and inductive heaters are desired. A wide array of devices such as a gas burner, a resistive heater, an induction heater, a griddle, a grill, a steamer, and a teppan yaki, perhaps with different sizes of each, is desirable in a domestic cooking appliance for a custom kitchen. However, to provide domestic cooking appliances with all of these devices in all possible configurations is not practically feasible from a manufacturing standpoint. One option would be to design and manufacture each possible configuration, but this likely would result in too many custom parts and configurations. Another option would be to include all appropriate electrical connections, including power and control, for all possible configurations and then populate each location on the domestic cooking appliance with the desired devices. This also is not desirable at least because a wiring harness with appropriate connectors and wiring provided to each location on the domestic cooking appliance would be overly cumbersome and expensive.

Thus, a need has developed to address one or more shortcomings of the prior art.

The present technology addresses one or more the shortcomings of the prior art.

An aspect of the present technology includes a domestic cooking appliance with a plurality of bays adapted to receive a plurality of different types of modules, e.g., modules adapted to provide different functions, detect the type of module and control the type of module.

Another aspect of the present technology includes a domestic cooking appliance comprising a cooktop including a plurality of bays adapted to receive a plurality of different types of modules; a module connected to a bay of the plurality of bays; and a controller, wherein the controller is adapted to determine the bay in which the module is connected and a type of the module of the plurality of different types of modules.

In examples, (a) the plurality of bays each comprise a first connector and the module comprises a second connector adapted to mate with the first connector, and the controller determines the type of the module of the plurality of different types of modules based upon a configuration of the second connector, (b) the first connector is an electrical connector, (c) the second connector comprises a plurality of pins and a jumper configuration between pins that causes the plurality of pins to generate a binary code when power is supplied to the plurality of pins, (d) the jumper configuration between pins includes no jumpers between pins, (e) the jumper configuration between pins includes one jumper between two pins, (f) the jumper configuration between pins includes a first jumper between a first pin and a second pin and a second jumper between a third pin and a fourth pin, (g) the controller determines the type of the module based upon a code assigned to the type of module, (h) the plurality of different types of modules comprises one or more of a gas burner, a resistive heater, an induction heater, a griddle, a grill, a steamer, and a teppan yaki, (i) the bays are cooktop bays and the plurality of different types of modules are cooktop modules, (j) the domestic cooking appliance further comprises a non-cooktop bay, and a non-cooktop module connected to the non-cooktop bay, and the controller is adapted to determine a type of the non-cooktop module, (k) the non-cooktop module comprises an oven, a warming drawer, or a steam oven, (l) the domestic cooking appliance further comprises a display, wherein the controller is adapted to update the display to indicate the bay in which the module is connected, (m) the domestic cooking appliance further comprises a display, wherein the controller is adapted to update the display to indicate the bay in which the module is connected and the type of module, (n) the domestic cooking appliance further comprises a combination of modules, including the module, connected to the plurality of bays, and the controller is adapted to determine whether the combination of modules together requires an excessive amount of electrical current, and disable at least one module of the combination of modules to prevent excessive current consumption by the domestic cooking appliance, (o) the domestic cooking appliance further comprises a display, wherein the controller is adapted to update the display to indicate the at least one disabled module, (p) the controller determines the at least one module to disable by allowing other modules that are previously powered to remain powered, (q) a first bay of the plurality of bays comprises a first connector, a second bay of the plurality of bays includes a second connector, and the first connector and the second connector are configured to mate with different connectors, (r) the different connectors are associated, respectively, with the plurality of different types of modules, and/or (s) the first connector and the second connector have different structural configurations of their respective mating interfaces.

Another aspect of the present technology includes a domestic cooking appliance comprising a plurality of bays adapted to receive a plurality of different types of modules, a plurality of modules each connected to a different bay of the plurality of bays, and a controller, wherein the controller is adapted to determine whether the plurality of modules together require an excessive amount of current, and disable a portion of the plurality of modules to prevent excessive current consumption by the domestic cooking appliance.

In examples, (a) the domestic cooking appliance further comprises a display, wherein the controller is adapted to update the display to indicate a type of module in each of the plurality of bays and to indicate which of the plurality of modules are disabled, (b) the controller determines the portion of the plurality of modules to disable by allowing other modules that are previously powered to remain powered, (c) the controller is adapted to determine a type of module of the plurality of different types of modules, (d) the controller associates a maximum power consumption the type of module and prevents the type of module from being turned on if doing so will cause the domestic cooking appliance to exceed a predetermined power threshold, and/or (e) the controller determines the type of module based upon a configuration of a connector of the type of module.

Another aspect of the present technology includes a method of controlling a domestic cooking appliance with a plurality of modules connected to the domestic cooking appliance, the method comprising: operating a first module; determining whether a second module can be operated without exceeding a predetermined power threshold; and powering the second module when the predetermined power threshold is not exceeded and preventing the second module from operating when the predetermined power threshold is exceeded.

Another aspect of the present technology includes a method of controlling a domestic cooking appliance, the method comprising: connecting a module of a plurality of different types of modules to the domestic cooking appliance; determining a type of the module; determining a position where the module is connected out of a plurality of possible positions; and displaying the type and the location of the module on a display of the domestic cooking appliance.

Another aspect of the present technology includes a domestic cooking appliance comprising: a plurality of bays into which different types of modules may be positioned; a module recognition interface in each of the plurality of bays; and a controller programmed to recognize, distinguish, and operate multiple different types of cooking modules in varying bay positions automatically.

In an example, the module recognition interface uses a jumper configuration associated with each different type of module to identify the type of module positioned in a respective bay.

Other aspects, features, and advantages of this technology will become apparent from the following detailed description when taken in conjunction with the accompanying drawings, which are a part of this disclosure and which illustrate, by way of example, principles of this technology.

### BRIEF DESCRIPTION OF THE DRAWINGS

FIG. 1 illustrates a home appliance including a cooktop;

FIG. 2 illustrates schematically the interconnection between components in a home appliance;

FIG. 3 illustrates schematically a connector used in the interconnections of FIG. 2; and

FIG. 4 illustrates a way in which icons can be displayed on the display of FIG. 2.

### DETAILED DESCRIPTION

The following description is provided in relation to several examples which may share common characteristics and features. It is to be understood that one or more features of any one example may be combinable with one or more features of the other examples. In addition, any single feature or combination of features in any of the examples may constitute additional examples.

Throughout this disclosure, terms such as first, second, third, etc. may be used. However, these terms are not intended to be limiting or indicative of a specific order, but instead are used to distinguish similarly described features from one another, unless expressly noted otherwise. Throughout this disclosure, “substantially” includes at least deviations from ideal or nominal values that are within manufacturing, operational and/or inspection tolerances.

The term electrical connector is also used throughout this disclosure. A connector encompasses at least an electrical connection, e.g., with a plug and/or receptacle, and may also encompass, additionally or alternatively, similar and/or related structures such as pin(s), jumper(s) between pin(s), wiring and/or wiring harness(es), etc.

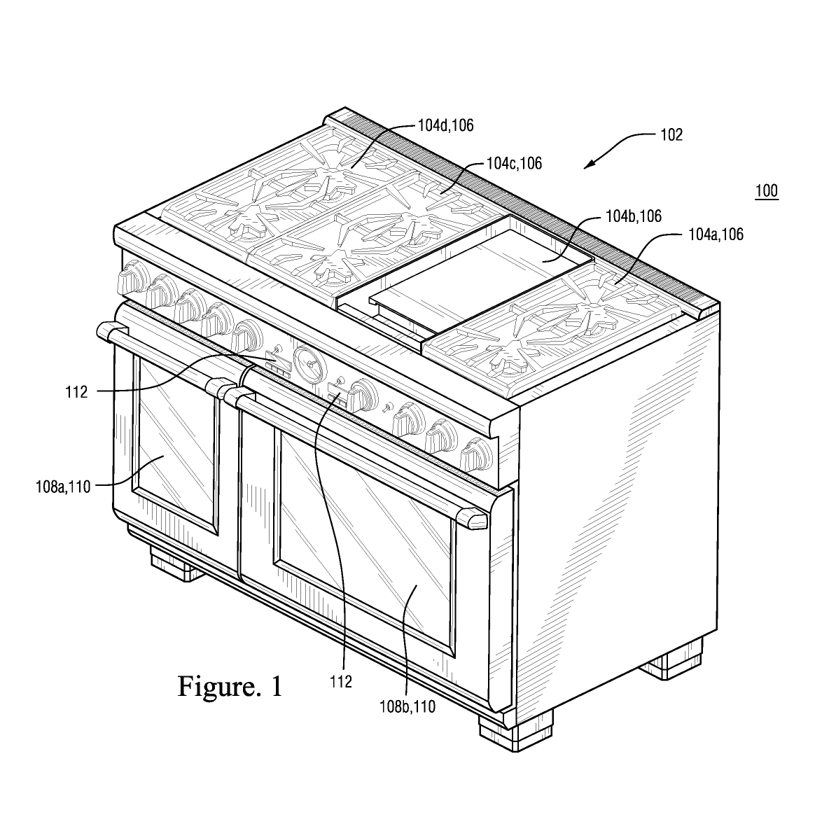

FIG. 1 illustrates an exemplary but non-limiting domestic cooking appliance 100 with a cooktop 102. The cooktop 102 includes a plurality of bays (e.g., four bays 104a, 104b, 104c, 104d are illustrated) populated with modules 106. There are numerous types of modules that may be dictated by the needs and desires of a user. Some exemplary but non-limiting examples of modules are a gas burner, a resistive heater, an induction heater, a griddle, a grill, a steamer, and a teppan yaki. Only two different types of modules are illustrated in FIG. 1 for ease of illustration only. Any type of module may be included or inserted into each of the bays. The domestic cooking appliance 100 also includes a plurality of non-cooktop bays (e.g., two bays 108a, 108b are illustrated) populated with non-cooktop modules 110. Some exemplary but non-limiting examples of non-cooktop modules are an oven, a warming drawer and a steam oven. The domestic cooking appliance 100 is illustrated with two displays 112, although any number of displays 112 may be included.

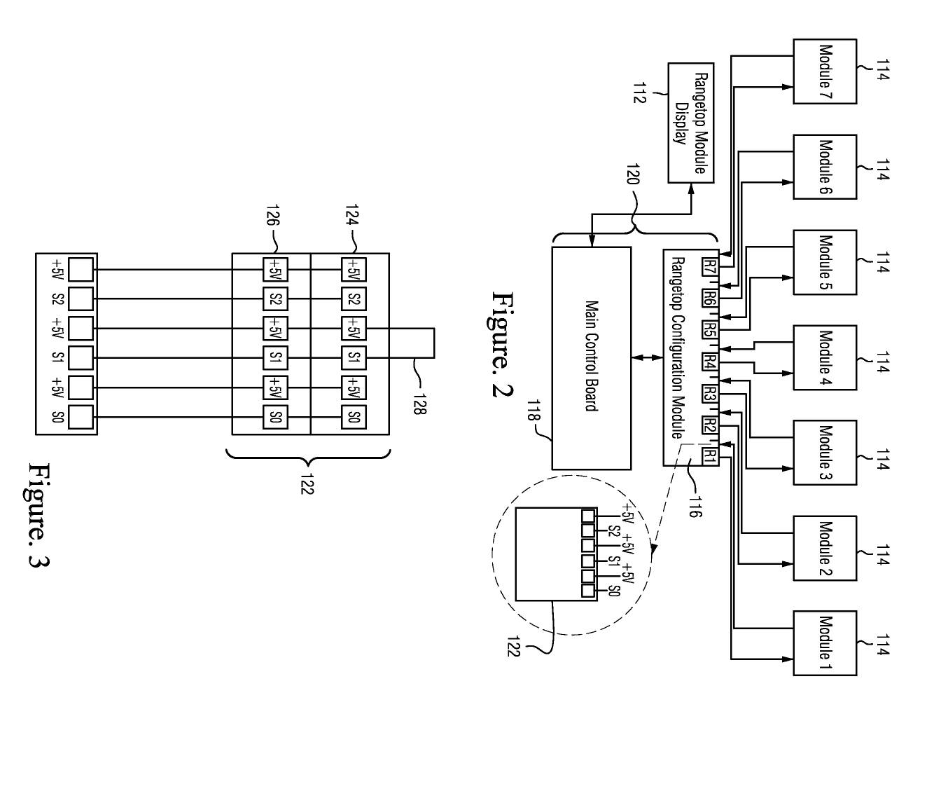

FIG. 2 illustrates an exemplary but non-limiting schematic according to the present technology. The schematic includes seven modules 114, which may be modules 106 or non-cooktop modules 110, but any number of modules 114 could be included with the present technology. Each of the modules 114 is at least functionally connected to a configuration module 116. A functional connection may include a connection that is able to relay information and/or provides electrical signals for control and/or power.

In FIG. 2, the configuration module 116 interfaces with a main control board 118. Together the configuration module 116 and main control board 118 may be considered a controller 120 for the domestic cooking appliance 100. Alternatively, either the configuration module 116 or main control board 118 alone may be considered a controller 120 for the domestic cooking appliance 100. The configuration module 116 and main control board 118 may be physically separate devices or the same physical device, in which case the configuration module 116 and main control board 118 may be considered as functional distinctions within the same physical device. The configuration module 116 and main control board 118 may be in the form of general purpose computers with appropriate programming or special purpose computers or any other suitable control system.

The functional connection between the modules 114 and the configuration may be in the form of an electrical connector 122, which is illustrated in greater detail in FIG. 3. The electrical connector 122 includes a first mating half 124 associated with a module 114 and a second mating half 126 associated with the configuration module 116. In an example of the present technology, a first mating half 124 associated with any of the types of modules 114 can physically mate with any second mating half 126. But as discussed below, each type of module 114 may include a functional difference with the respective first mating half 124.

As illustrated in FIG. 3, the electrical connector 122 includes signal lines, illustrated as three signal lines S0, S1, S2, and voltage lines, illustrated as three lines with five volts. With this configuration, the electrical connector effectively can function as a three digit binary code by including connections between one or more of the signal lines S0, S1, S2 and a voltage line. Thus, the respective first mating half 124 may include a functional difference. Of course, any number signal and voltage lines may be included so as to provide a smaller or larger binary code if necessary.

FIG. 3 illustrates a jumper 128 or similar electrical connection that connects S1 to a five volt line. In this configuration, S0 and S2 would have zero voltage and S1 would have a five volt signal, corresponding to a binary number two. Of course, any combination of jumpers 128 or lack of jumper 128 may be provided to correspond to different codes or binary numbers. In the configuration illustrated in FIG. 3, from zero to three jumpers 128 could be provided, and of course a higher number is possible if more signal lines are provided. The configuration module 116 may include appropriate logic, either through hardware or software, to identify or correlate a particular binary code with a type of module 114. Based upon the identified module, appropriate control decisions can be performed by the controller 120 and/or domestic cooking appliance 100. Use of a jumper 128 across signal lines may be beneficial because it provides a simple and cost effective solution.

Although an electrical connector 122 with a jumper 128 has been described above, the present technology is not so limited. Any interface that allows for identification of the modules 114 is envisioned with the present technology. For example, any piece of hardware or software that provides appropriate identification may be used. Exemplary but non-limiting examples include radio frequency identification (RFID), software codes accessible by a communications bus, and/or physical keys that provide identification.

By associating each type of module 114 with a code, the controller 120 can identify the type of module 114 connected in each of the cooktop bays and/or non-cooktop bays. This provides several advantages.

For example, during the manufacturing process, the domestic cooking appliance 100 can include a wiring harness (not illustrated) that allows any type of module 114 to be connected in any type of bay, either the cooktop bays or the non-cooktop bays. With such a universal wiring harness, customized domestic cooking appliances 100 with any combination of types of modules 114 can be manufactured. If the wiring harness were not universal, providing wiring for each type of module 114 in each possible bay would be prohibitive because of the large number of different parts required.

The controller 120 can also use the identity of each type of module 114 for control purposes. For example, different types of modules 114 may have very different electrical power consumption requirements—a gas burner may require electrical power only to drive an ignition source whereas an induction heater may continuously draw several amps of electricity during a heating operation. If several induction heaters are operated at the same time, the current draw may be such that the power supply connected to the domestic cooking appliance 100, or the domestic cooking appliance 100 itself, may be unable to handle the current necessary to operate several induction heaters. In this scenario, the controller 120 can determine that “too many” induction heaters are installed in the domestic cooking appliance 100 and only allow a number of induction heaters to be operated that will remain within an appropriate current level. In other words, if all of the modules 114 installed are induction heaters, and only two induction heaters can be safely operated, the controller 120 can prevent or disable a third module 114 from being operated after two other modules 114 are operated. The controller 120 may allow a first module 114 to be turned on because the current draw is not excessive, followed by a second module 114 and so on until the current limit would be exceeded by turning on another module 114. At that point, any module 114 that would cause excessive current draw would be prevented from operating. Of course, this control scheme can apply to any type or combination of modules 114 that may draw excessive current or other resource. For example, if a limit is placed on natural gas consumption, gas burners could also be disabled once a limit of gas consumption is reached by one or more other burners.

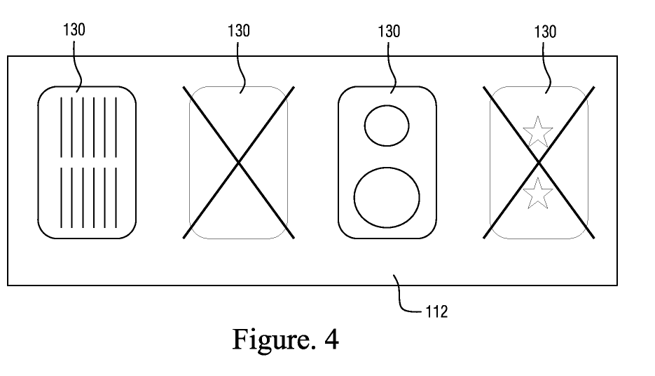

The domestic cooking appliance 100 can also use the identification of the modules 114 in conjunction with the display 112. As illustrated in FIG. 4, the display 112 can include symbols 130 or other nomenclature such as text, color-coded lights, images, etc., that corresponds to a type of the module 114. When the type of module 114 is detected, the display can provide some sort of indication on the display that corresponds to the type of module 114 and location in a given bay 104 or non-cooktop bay 108. The display can also provide an indication when a module 114 has been disabled, as detailed above, and is shown in FIG. 4 by way of an “X” through two of the symbols. Any indication that a module 114 has been disabled may be provided. For example, the symbols could be illuminated only when enabled (not disabled), grayed out when disabled, or any other indication that would inform users that the module 114 is disabled or otherwise unavailable.

Identification of the modules 114 can also be used to reconfigure a domestic cooking appliance 100. For example, if a new location or configuration of the modules 114 that are installed in a domestic cooking appliance is desired, the modules can be disconnected and moved between locations and the domestic cooking appliance will identify the new locations and operate accordingly. Similarly, spare or new modules 114 could be swapped with existing modules 114 if new or different features are desired for the domestic cooking appliance 100, and the domestic cooking appliance 100 will identify the new modules 114 and operate accordingly.

Of course, the preceding examples are not limiting and any changes in the control scheme of the domestic cooking appliance 100 can take advantage of identifying the modules 114 that have been installed in accordance with the present technology.

While the present technology has been described in connection with several practical examples, it is to be understood that the technology is not to be limited to the disclosed examples, but on the contrary, is intended to cover various modifications and equivalent arrangements included within the spirit and scope of the technology.

What is claimed is:

1. A domestic cooking appliance comprising:
a plurality of bays adapted to receive a plurality of different types of modules;
a module connected to a bay of the plurality of bays; and
a controller, wherein the controller is adapted to determine:
the bay in which the module is connected and
a type of the module of the plurality of different types of modules.

2. The domestic cooking appliance according to claim 1, wherein the plurality of bays each comprise a first connector and the module comprises a second connector adapted to mate with the first connector, and the controller determines the type of the module of the plurality of different types of modules based upon a configuration of the second connector.

3. The domestic cooking appliance according to claim 2, wherein the first connector is an electrical connector.

4. The domestic cooking appliance according to claim 3, wherein the second connector comprises a plurality of pins and a jumper configuration between pins that causes the plurality of pins to generate a binary code when power is supplied to the plurality of pins.

5. The domestic cooking appliance according to claim 4, wherein the jumper configuration between pins includes no jumpers between pins.

6. The domestic cooking appliance according to claim 4, wherein the jumper configuration between pins includes one jumper between two pins.

7. The domestic cooking appliance according to claim 4, wherein the jumper configuration between pins includes a first jumper between a first pin and a second pin and a second jumper between a third pin and a fourth pin.

8. The domestic cooking appliance according to claim 1, wherein the controller determines the type of the module based upon a code assigned to the type of module.

9. The domestic cooking appliance according to claim 1, wherein the plurality of different types of modules comprises one or more of a gas burner, a resistive heater, an induction heater, a griddle, a grill, a steamer, and a teppan yaki.

10. The domestic cooking appliance according to claim 1, wherein the bays are cooktop bays and the plurality of different types of modules are cooktop modules.

11. The domestic cooking appliance according to claim 1, further comprising:
a non-cooktop bay; and
a non-cooktop module connected to the non-cooktop bay,
wherein the controller is adapted to determine a type of the non-cooktop module.

12. The domestic cooking appliance according to claim 11, wherein the non-cooktop module comprises an oven, a warming drawer, or a steam oven.

13. The domestic cooking appliance according to claim 1, further comprising a display, wherein the controller is adapted to update the display to indicate the bay in which the module is connected.

14. The domestic cooking appliance according to claim 1, further comprising a display, wherein the controller is adapted to update the display to indicate the bay in which the module is connected and the type of module.

15. The domestic cooking appliance according to claim 1, further comprising:
a combination of modules, including the module, connected to the plurality of bays, wherein the controller is adapted to:
determine whether the combination of modules together requires an excessive amount of electrical current, and
disable at least one module of the combination of modules to prevent excessive current consumption by the domestic cooking appliance.

16. The domestic cooking appliance according to claim 15, further comprising a display, wherein the controller is adapted to update the display to indicate the at least one disabled module.

17. The domestic cooking appliance according to claim 15, wherein the controller determines the at least one module to disable by allowing other modules that are previously powered to remain powered.

18. The domestic cooking appliance according to claim 1, wherein a first bay of the plurality of bays comprises a first connector, a second bay of the plurality of bays includes a second connector, and the first connector and the second connector are configured to mate with different connectors.

19. The domestic cooking appliance according to claim 18, wherein the different connectors are associated, respectively, with the plurality of different types of modules.

20. The domestic cooking appliance according to claim 18, wherein the first connector and the second connector have different structural configurations of their respective mating interfaces.

21. A domestic cooking appliance comprising:
a plurality of bays adapted to receive a plurality of different types of modules;
a plurality of modules each connected to a different bay of the plurality of bays; and
a controller, wherein the controller is adapted to:
determine whether the plurality of modules together require an excessive amount of current, and
disable a portion of the plurality of modules to prevent excessive current consumption by the domestic cooking appliance.

22. The domestic cooking appliance according to claim 21, further comprising a display, wherein the controller is adapted to update the display to indicate a type of module in each of the plurality of bays and to indicate which of the plurality of modules are disabled.

23. The domestic cooking appliance according to claim 21, wherein the controller determines the portion of the plurality of modules to disable by allowing other modules that are previously powered to remain powered.

24. The domestic cooking appliance according to claim 21, wherein the controller is adapted to determine a type of module of the plurality of different types of modules.

25. The domestic cooking appliance according to claim 24, wherein the controller associates a maximum power consumption the type of module and prevents the type of module from being turned on if doing so will cause the domestic cooking appliance to exceed a predetermined power threshold.

26. The domestic cooking appliance according to claim 24, wherein the controller determines the type of module based upon a configuration of a connector of the type of module.

27. A method of controlling a domestic cooking appliance with a plurality of modules connected to the domestic cooking appliance, the method comprising:
operating a first module;
determining whether a second module can be operated without exceeding a predetermined power threshold; and
powering the second module when the predetermined power threshold is not exceeded and preventing the second module from operating when the predetermined power threshold is exceeded.

28. A method of controlling a domestic cooking appliance, the method comprising:
connecting a module of a plurality of different types of modules to the domestic cooking appliance;
determining a type of the module;
determining a position where the module is connected out of a plurality of possible positions; and
displaying the type and the position of the module on a display of the domestic cooking appliance.

29. A domestic cooking appliance comprising:
a plurality of bays into which different types of modules may be positioned;
a module recognition interface in each of the plurality of bays; and
a controller programmed to recognize, distinguish, and operate multiple different types of cooking modules in varying bay positions automatically.

30. The domestic cooking appliance according to claim 29, wherein the module recognition interface uses a jumper configuration associated with each different type of module to identify the type of module positioned in a respective bay.
